(19) United States
(12) Patent Application Publication
(10) Pub. No.: US 2012/0202466 A1
(43) Pub. Date: Aug. 9, 2012

(54) SYSTEM AND METHODS THEREOF FOR CONTROLLED DELIVERY OF MESSAGES TO MOBILE DEVICES

(75) Inventor: Arnon Zangvil, Tel Aviv (IL)

(73) Assignee: Arnon Zangvil, Tel Aviv (IL)

(21) Appl. No.: 13/367,389

(22) Filed: Feb. 7, 2012

Related U.S. Application Data
(60) Provisional application No. 61/440,123, filed on Feb. 7, 2011.

(51) Int. Cl. H04W 4/16; H04W 4/12

(52) U.S. Cl. 455/412.1

(57) ABSTRACT

It has been shown that drivers who handle messages delivered to their mobile devices, such as cellular phone, pay less attention to their driving and therefore are more likely to be involved in accidents. Accordingly the mobile device is configured to detect when the mobile device is in motion at a speed likely to be a vehicle speed and notify the system sending the messages to the mobile device to delay sending of such messages to the mobile device until it becomes essentially stationary once more. In one embodiment calls are also not directed to the mobile device while in motion. In another embodiment the status is made available to be checked by applications and/or users for the purpose of determination whether or not to send messages or otherwise contact the mobile device.

### CROSS REFERENCE TO RELATED APPLICATIONS

This application claims the benefit of U.S. provisional application No. 61/440,123 filed on Feb. 7, 2011, the contents of which are herein incorporated by reference.

### TECHNICAL FIELD

The invention generally relates to the transmission and/or reception of messages to/from a mobile device, and more specifically to ceasing of the ability to receive/send message by a mobile device when in motion at vehicle like speeds.

### BACKGROUND OF THE INVENTION

It has been shown that drivers who handle messages, such as those provided by the short message service (SMS), delivered to their mobile devices, such as cellular phone, pay less attention to their driving and therefore are more likely to be involved in accidents. Therefore several solutions have been proposed to prevent, or otherwise at least control, the reception of such messages that are a major distraction for a driver of a vehicle.

One prior art solution known as DriveSafe.ly™ is powered by a technology from iSpeech.org. The driver is requested to press an ON button on the mobile device to activate a service that reads aloud a message received by the mobile device, upon, for example, reception of the message. Upon depressing an OFF button the mobile device resumes to the normal operation respective of receiving such messages. The solution requires the user to enter such a safe mode but still, messages are received and the attention of the drive may be directed from the road conditions to the message to be either received, or in other cases be sent, even when using voice-to-text kind of solutions. Obviously, if the user forgot to activate or otherwise enter the safety mode the solution is useless anyway.

Another solution is provided by ZoomSafer, Inc. that provides safe driving software for smart phones. The solution integrates with the in-vehicle Bluetooth technology to determine when the vehicle is in motion and one connected eliminating the temptation to text, email or browse the web while driving. The ZoomSafer solution can further inform parties attempting to communicate with the smart phone that the person is driving and cannot accept or otherwise handle the call. The ZoomSafer solution suppresses any kinds of alerts related to e-mail or text messages and sends custom auto-replies configurable by the user. The suppressing of the alerts does not prevent the messages from coming in and still may tempt the user to peek to review them from time-to-time. Moreover, just like the solution from DriveSafe.ly the ZoomSafer solution is deficient in at least the fact that a user can easily deactivate the Bluetooth connection to prevent the solution from kicking in and activating its safety features, even if the application itself is activated or may not even be deactivated by design. Of course, the use of the built-in global positioning system (GPS) circuit built in most smart phones today allows the ZoomSafer solution to provide motion information even if no Bluetooth connection is available.

It would therefore be advantageous to provide a solution that overcomes the deficiencies of the prior art by eliminating the temptation of a user to check on messages received by the mobile device.

### SUMMARY OF THE INVENTION

Certain embodiments of the invention disclosed herein include a method for controlling sending messages to a mobile device. The method comprises receiving a message for the mobile device at a messages gateway and checking the mobile device motion status as registered in the messages gateway and if the mobile device is in a motion state storing the at least a message in a buffer, and forwarding the at least a message to the mobile device if the mobile device is in a stationary state.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a schematic diagram of a system in accordance with the principles of the invention

FIG. 2 is a flowchart of an application on a mobile device operative according with the principles of the invention

FIG. 3 is a flowchart describing the operation of a gateway receiving indication of the status of the mobile device

FIG. 4 is a flowchart describing the operation of the gateway when receiving a message directed to the mobile device

FIG. 5 is a flowchart describing the operation of the gateway when having messages in a buffer of the gateway waiting to be sent to the mobile device

### DETAILED DESCRIPTION OF THE INVENTION

The embodiments disclosed herein are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

It has been shown that drivers who handle messages delivered to their mobile devices, such as cellular phone, pay less attention to their driving and therefore are more likely to be involved in accidents. Accordingly the mobile device is configured to detect when the mobile device is in motion at a speed likely to be a vehicle speed and notify the system sending the messages to the mobile device to delay sending of such messages to the mobile device until it becomes essentially stationary once more. In one embodiment calls are also not directed to the mobile device while in motion. In another embodiment the status is made available to be checked by applications and/or users for the purpose of determination whether or not to send messages or otherwise contact the mobile device.

To overcome the known deficiencies of the prior art a solution that comprises a solution comprising an application and/or agent, hereinafter referred to as the application, activated on the mobile device is provided on one hand, and a gateway for handling messages directed to the mobile phone and communicatively connected with the application on the other hand. The application detects the motion of the mobile device and upon detecting a motion above a threshold velocity, generally corresponding to a speed associated with traveling in a moving vehicle, sending an indication to the gateway that the mobile device is in motion. Conversely, when the application detects that the mobile devices in stationary or otherwise in a speed lower than a predefined threshold, an indication is sent to the gateway to indicate that the mobile device is stationary. The detection of the velocity of the mobile device may be performed using one or more motion detection technologies which include, but are not limited to, global positioning system (GPS) indication, cellular positioning, and the likes. Other technologies for motion detection may be used, including but not limited to those that relate to Bluetooth® and/or WiFi network connect and disconnect information.

On the gateway side once an indication is received from a mobile device the status of that mobile device is updated. Upon receiving a message directed to the mobile device the gateway first checks the status of the mobile device and if the indication is that the mobile device is in motion the delivery of the message is delayed, for example, by storing the message in a buffer. Periodically an attempt is made to resend the message by checking if the mobile device has returned to a stationary position.

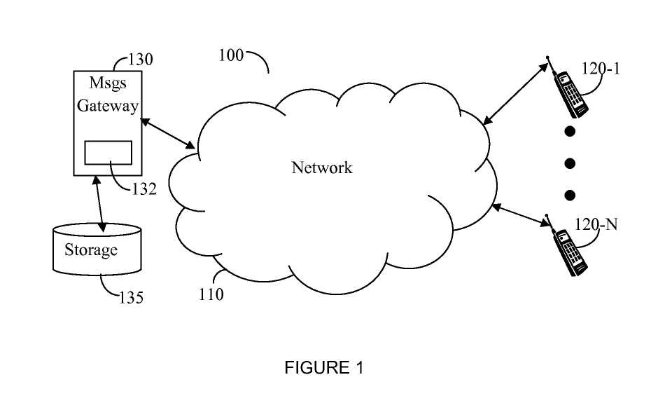

FIG. 1 depicts an exemplary and non-limiting schematic diagram of a system 100 in accordance with the principles of the invention. A plurality of mobile devices 120, for example smart phones 120-1 through 120-N, are communicatively coupled to a communication network 110. The mobile devices 120 are equipped with an application operative as described in more detail herein below to achieve the principles of the invention. To the network 110 there is coupled a message gateway 130 that is equipped with an application 132 to receive indications from the applications on the mobile devices 120 and update the motion status of each such mobile device 120. The gateway 130 maybe further coupled to a storage 135 for the purpose of storing messages received for a mobile device, when it is determined that such mobile device is in motion. For example, if mobile device 120-N sends a message to mobile device 120-1 but mobile device 120-1 is in motion at a speed typical to that of a moving vehicle, then such message is stored in the storage 135 for future delivery as explained in greater detail herein below. Messages may be sent to a mobile device 120 not only from another one of the mobile devices 120 but from other means, for example a user node coupled to the network directly or indirectly (not shown), the delivery of the message being routed via the gateway 130 for operation as described in greater detail herein below.

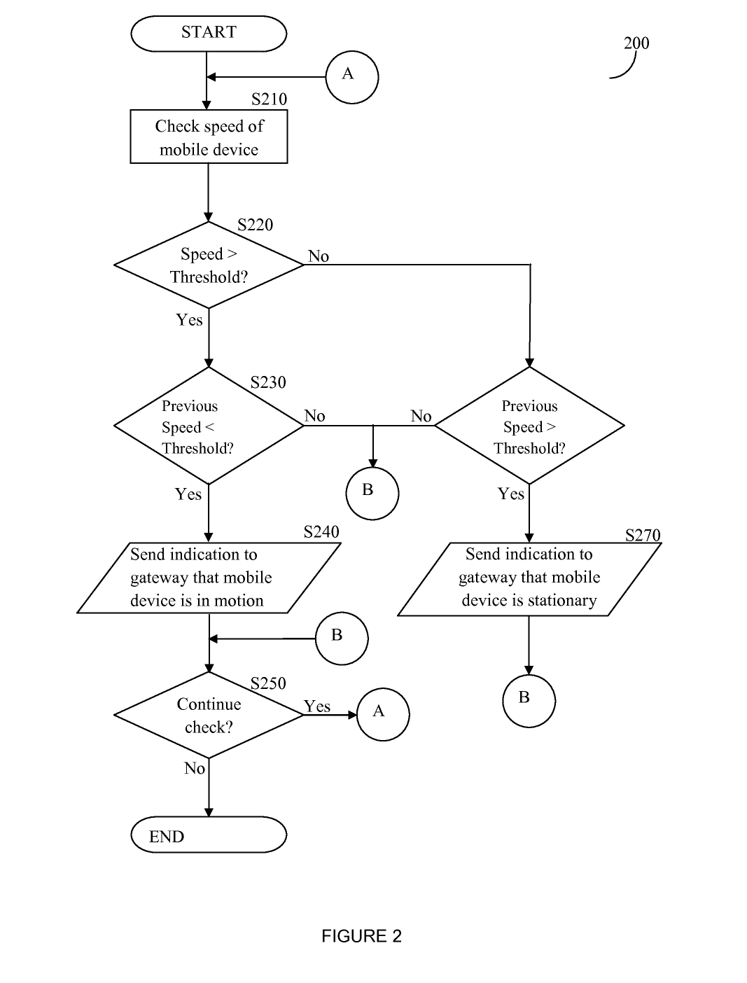

FIG. 2 depicts an exemplary and non-limiting flowchart 200 of an application on a mobile device operative according with the principles of the invention. In S210 the speed of the mobile device is checked. The speed may be determined in various ways that are outside the scope of this invention but that would be known to those of ordinary skill in the art, and include, without limitation, the use of GPS information or cellular data. In S220 it is determined if the detected speed is above a predetermined threshold. The threshold is determined to establish positively that the mobile device is at a speed that is typical to that of a vehicle rather than a person walking or running. However, this speed may be configurable and may further take into account additional parameters such as the location of the mobile device 120. For example, if it is determined that the mobile device is on a road or highway than even if a slower speed is detected it may be determined to be in a moving vehicle. Hence upon determination that the speed is above a predetermined threshold then execution continues with S230; otherwise, execution continues with S260. In S230 it is checked whether in the immediately previous check the speed was below the threshold and if so execution continues with S240; otherwise, execution continues with S250. In S240 an indication is sent to the gateway, for example gateway 130, that the mobile device is determined to be in motion. In S250 it is checked whether the application should continue checking and if so execution continues with S210; otherwise, execution terminates. In S260 it is checked whether the previous speed was above the threshold and if so execution continues with S270; otherwise, execution continues with S250. In S270 an indication is sent to the gateway, for example gateway 130, that the mobile device is essentially stationary, after which execution continues with S250. With respect to changing status from motion to stationary, an embodiment of the invention may include a delay to ensure that the mobile device is actually stationary and that the lack of motion at a particular time is not a result of a traffic jam or merely standing at a red light. Such delays may be configurable to adjust for different traffic conditions.

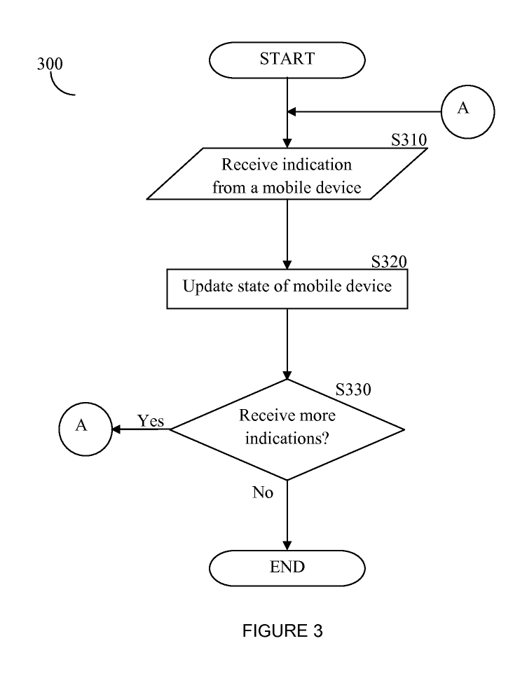

FIG. 3 depicts an exemplary and non-limiting flowchart 300 describing the operation of a gateway receiving indication of the status of the mobile device. In S310 the gateway, for gateway 130, receives an indication from a mobile device, for example mobile device 120-1. The indication provides the state of the respective mobile device which may be in the state of motion, when it is determined that it is moving at a speed of a vehicle or as otherwise discussed hereinabove, or when it is stationary. In S320 the state of the mobile device is updated in the gateway's memory. In S330 it is checked if the system is continue to receive more indications and if so execution continues with S310; otherwise execution terminates.

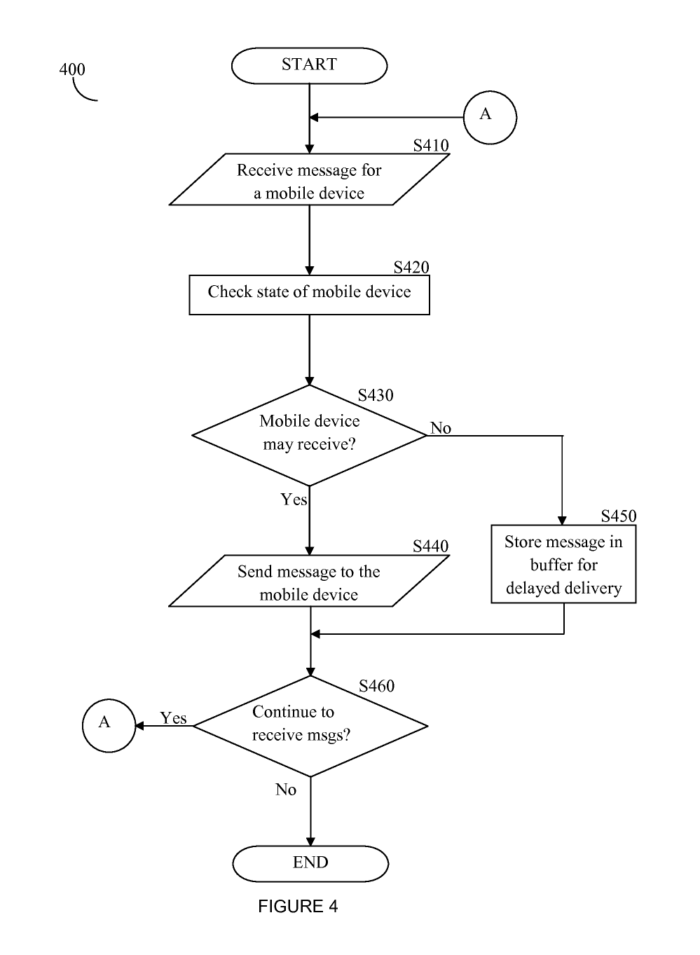

FIG. 4 depicts an exemplary and non-limiting flowchart 400 describing the operation of the gateway when receiving a message directed to the mobile device. In S410 a message is received by the gateway, for example gateway 130, for a mobile device, for example, mobile device 120-1. In S420 the state of the mobile device is checked and in S430 it is determined whether the mobile device may receive a message at that time. If the mobile device may receive the message execution continues with S440; otherwise execution continues with S450. In S440 the message is sent directly to the mobile device. In S450 the message is stored in a buffer, for example in storage 135, for later retrieval. In S460 it is checked whether the gateway is to continue to receive messages and is so execution continues with S410; otherwise, execution continues terminates.

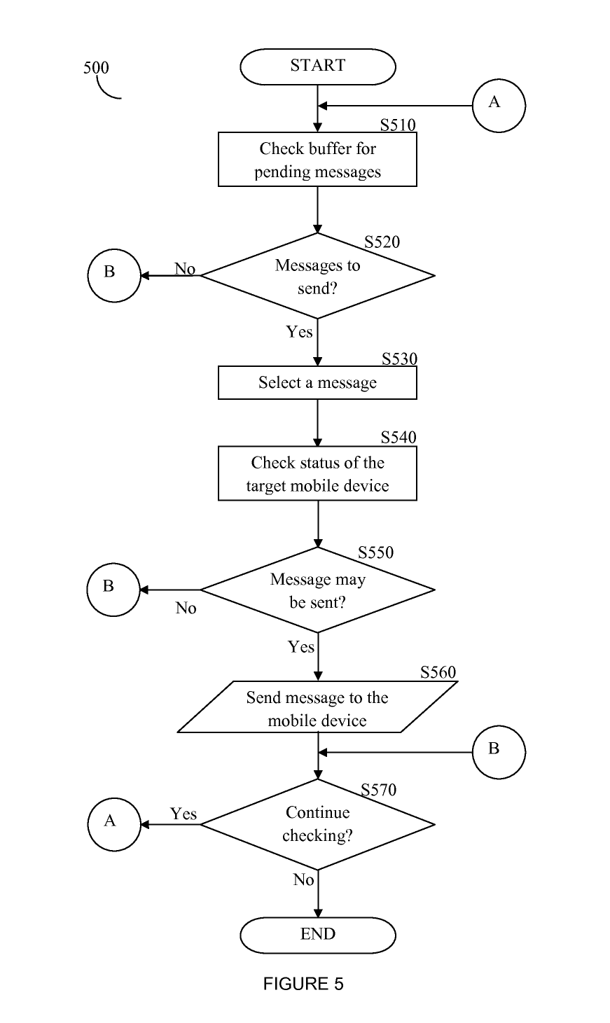

FIG. 5 depicts an exemplary and non-limiting flowchart 500 describing the operation of the gateway when having messages in a buffer of the gateway waiting to be sent to the mobile device. In S510 the buffer, for example storage 135, is checked for existence of messages not yet sent to a mobile device. In S520 if messages are in the buffer then execution continues with S530; otherwise execution continues with S570. In S530 a message is selected from the messages in the buffer. The selection may use a variety of strategies that are outside the scope of the instant invention but that would be readily understood by those of ordinary skill in the art. One such strategy may be to select the oldest message in the buffer assuming it is the more likely one to be ready to be sent to its intended mobile device. In S540 the status of the mobile device to which the selected message is intended to is checked. In S550 it is determined that if the mobile device is in a stationary state then the message may be sent and execution continues with S560; otherwise, execution continues with S570. In S560 the selected message is sent to the targeted mobile device and, once sent, the message is removed from the buffer. In S570 it is checked whether the gateway should continue checking the buffer and if so execution continues with S510; otherwise, execution terminates.

In one embodiment of the invention not only messages directed to a mobile device are restricted from being directed to the mobile device but also any form of communication, as long as it is detected that the mobile device is in motion as explained hereinabove. Such withholding of delivery may equally apply to other kinds of communication, including but not limited to e-mail communication. In yet another embodiment of the invention the status of the mobile device is published or otherwise made available to applications for the purpose of determining the status of the mobile device. By publishing the status on the web, using for example and without limitation, the availability of social networks, for example as an application on Facebook®, it is possible for a user to identify when a mobile device is not available for the receiving of a message. The status gets updated based on the motion status of the mobile device as explained hereinabove. Furthermore, the motion status of the mobile device may be made available for access by applications in general, for example an application for sending SMS messages to the mobile device that would check the status of the mobile device prior to attempting to send a message to the mobile device. Furthermore, in an embodiment of the invention, when an attempt is made to call a mobile device in a motion based in its motion status, the caller maybe first advised to consider the fact that the person maybe driving and for safety reasons delay the call for another time. The user may then disconnect or otherwise continue to call until such time that the user of the mobile device opts to answer the received call.

In yet another embodiment of the application the possibility that the automatic motion detection is not operative, for example due to lack of communication with GPS satellites. In such a case the user interface on the mobile device may provide the ability to allow the user to indicate to the system when motion is in place as well as an indication when not in such motion.

The principles of the invention are implemented as hardware, firmware, software, or any combination thereof. Moreover, the software is preferably implemented as an application program tangibly embodied on a program storage unit or non-transitory computer readable medium or a non-transitory machine-readable storage medium that can be in a form of a digital circuit, an analogy circuit, a magnetic medium, the likes, or combination thereof. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for controlling sending at least a message to a mobile device comprising:
receiving the at least a message for the mobile device at a messages gateway; and
checking the mobile device motion status as registered in the messages gateway and if the mobile device is in a motion state storing the at least a message in a buffer, and forwarding the at least a message to the mobile device if the mobile device is in a stationary state.

2. The method of claim 1, further comprising:
receiving from the mobile device an indication respective of the motion; and
updating the mobile device motion status in the messages gateway.

3. The method of claim 2, wherein the indication is one of a motion state and a stationary state.

4. The method of claim 3, further comprising:
checking the buffer periodically for messages and, if at least a message exists in the buffer checking the motion status of its targeted mobile device and sending the message if the motion status of its targeted mobile device indicates a stationary state.

5. The method of claim 3, wherein the motion state is determined by having the mobile device to check if the motion of the mobile device is above a threshold velocity.

6. The method of claim 3, wherein the stationary state is determined by having the mobile device to check if the motion of the mobile device is below a threshold velocity.

7. The method of claim 3, wherein the indication of the mobile device being in the stationary state is sent after a predetermined time delay to ensure that the stationary state is maintained.

8. The method of claim 1, further comprising:
removing the message from the buffer once the message has been sent to the targeted mobile device.

9. A computer program product in a tangible medium with instruction for causing a computing device to control sending of messages to a mobile device comprising:
receiving a message targeted for the mobile device at a messages gateway; and
checking the mobile device motion status as registered in the messages gateway and if the mobile device is in a motion state storing the message in a buffer, and forwarding the message to the mobile device if the mobile device is in a stationary state.

10. The computer program product of claim 9, further comprising:
receiving from the mobile device an indication respective of the motion; and
updating the mobile device motion status in the messages gateway.

11. The computer program product of claim 10, wherein the indication is one of a motion state and a stationary state.

12. The computer program product of claim 11, further comprising:
checking the buffer periodically for messages and, if at least a message exists in the buffer checking the motion status of its targeted mobile device and sending the message if the motion status of its targeted mobile device indicates a stationary state.

13. The computer program product of claim 11, wherein the motion state is determined by having the mobile device to check if the motion of the mobile device is above a threshold velocity.

14. The computer program product of claim 11, wherein the stationary state is determined by having the mobile device to check if the motion of the mobile device is below a threshold velocity.

15. The computer program product of claim 11, wherein the indication of the mobile device being in the stationary state is sent after a predetermined time delay to ensure that the stationary state is maintained.

16. The computer program product of claim 9, further comprising:
removing the message from the buffer once the message has been sent to the targeted mobile device.

17. A system for controlling communication with a mobile device comprising:
a gateway for receiving the communication intended to the mobile device and forwarding the communication when the mobile device is in a motion status that allows the delivery of the communication;
a storage for storing the motion status of the mobile device; and
an interface to a network communicatively coupled to the mobile device for receiving updates regarding the motion status of the mobile device.

18. The system of claim 17, wherein the communication is a message.

19. The system of claim 18, further comprising:
a buffer for storing the message if it cannot be sent to the mobile device due to an inappropriate motion status;

20. The system of claim 17, wherein the motion status is one of: stationary state and motion state.

21. The system of claim 20, wherein the motion state is determined by having the mobile device to check if the motion of the mobile device is above a threshold velocity.

22. The system of claim 20, wherein the stationary state is determined by having the mobile device to check if the motion of the mobile device is below a threshold velocity.

23. The system of claim 20, wherein the indication of the mobile device being in the stationary state is sent after a predetermined time delay to ensure that the stationary state is maintained.

24. The system of claim 19, wherein the at least a message is delivered to the mobile device upon determination that the mobile device is in a stationary state.

25. The system of claim 19, wherein the buffer is checked periodically for messages and, if at least a message exists in the buffer checking the motion status of its targeted mobile device and sending the message if the motion status of its targeted mobile device indicates a stationary state.

26. The system of claim 25, wherein a message in the buffer is removed once it has been sent to the targeted mobile device.

27. The system of claim 17, wherein the gateway provides the motion status of the mobile device responsive of receiving a query.

28. The system of claim 17, wherein the gateway publishes the motion status of the mobile device on the web.

29. The system of claim 17, wherein the updates regarding the motion status are received at least one of: periodically, on-demand.
